(19) United States
(12) Patent Application Publication
(10) Pub. No.: US 2010/0018286 A1
(43) Pub. Date: Jan. 28, 2010

(54) Calibration apparatus, contact judging method and semiconductor testing apparatus

(76) Inventors: Masaya Numajiri, Tokyo (JP); Kazuhiro Shimawaki, Tokyo (JP)

Correspondence Address: Muramatsu & Associates, 114 Pacifica, Suite 310, Irvine, CA, 92618, US

(21) Appl. No.: 12/311,685

(22) PCT Filed: Oct. 9, 2007
(86) PCT No.: PCT/JP2007/069663

§ 371 Date: Aug. 3, 2009

(30) Foreign Application Priority Data
Oct. 10, 2006 (JP) 2006-276552

(51) Int. Cl. G01D 18/00

(52) U.S. Cl. 73/1.79

(57) ABSTRACT

A calibration apparatus for probe contact conformity judgment is applicable to multiple pin measurement at a low cost with an easy operation. The calibration apparatus is provided with a calibration robot for bringing a probe into contact with a prescribed position on a performance board and a judging means for judging conformity of the contact. The calibration robot is provided with a calibration module having a driver for outputting an inspection signal and a comparator for inputting a reflected wave. The judging means judges conformity of the contact based on the timing at which a reflected wave is inputted into the comparator through the probe after the inspection signal is outputted to the probe from the driver.

### TECHNICAL FIELD

The present invention relates to a calibration apparatus provided with a calibration robot which performs calibration of a driver or a comparator of pin electronics, a contact judging method for judging whether a probe is accurately in contact with a predetermined position of a performance board, as well as to a semiconductor apparatus provided with the above-mentioned calibration apparatus. In particular, the present invention relates to a calibration apparatus, a contact judging method and a semiconductor testing apparatus which enable probe contact judgment to be performed at a low cost with an easy operation.

### BACKGROUND OF THE INVENTION

A semiconductor testing apparatus is an apparatus for judging whether a device under test has correct properties. This test is performed in such a manner that a prescribed signal is inputted to a device under test and a signal outputted from the device to be measured is analyzed, thereby judging whether the properties of the device are correct. Accordingly, in a semiconductor testing apparatus, a driver which sends a signal to a device under test or a comparator which inputs the signal outputted by the device under test are provided for each pin.

In this semiconductor testing apparatus, timing calibration is performed in order to adjust the phase of a test pattern signal to be applied to each input pin of a device under test.

In conventional calibration methods, a comparator is provided dedicatedly for calibration in addition to a comparator for device testing, and a plurality of drivers for device testing are sequentially connected to the comparator, whereby calibration of these drivers for device testing is performed. Furthermore, a driver for calibration is provided in addition to a driver for device testing, and a plurality of comparators for device testing are sequentially connected, whereby calibration of these comparators for device testing is performed.

FIG. 12 shows the configuration of such semiconductor testing apparatus. As shown in FIG. 12, a semiconductor testing apparatus 1 is provided with a tester main body (test head) 10, a calibration robot 20 and a performance board 30.

The tester main body 10 is provided with pin electronics 11 comprising driver groups DR1 to DRn and comparator groups CP1 to CPn.

The drivers DR1 to DRn apply a signal, which is synchronized with an inputted clock signal, to a device under test (not shown). The comparators CP1 to CPn compare the signal outputted by the device under test in correspondence with the applied signal with a strobe signal, thereby judging the logic of the outputted signal.

A calibration robot 20 is an apparatus for performing timing calibration. In order to bring a probe 21 into contact with a pin on a performance board 30, the calibration robot 20 is allowed to move in the X-Y-Z direction. Within this calibration robot 20, a calibration module 22 having a driver DRx and a comparator CPx for calibration is provided and connected to the probe 21.

The method of calibration will be explained with reference to FIGS. 13 to 16.

The calibration is defined by adjustment of the skew of the drivers DR1 to DRn or the skew of the comparators CP1 to CPn for each pin in the pin electronics 11.

First, the skew of the driver DR1 of pin 1 is adjusted. In this case, as shown in FIG. 13, in the calibration module 22, a switch SW2 on the comparator CPx side is turned ON and a switch SW1 on the driver DRx side is turned OFF, and a signal outputted by the driver DR1 of the pin electronics 11 is sent to a comparator CPx of the calibration module 22 through the performance board 30.

In this comparator CPx, as shown in FIG. 14, the position at which the signal rises (or falls) is detected, whereby the skew of the driver DR1 is adjusted.

Then, the skew of the comparator CP1 of pin 1 is adjusted.

In this case, as shown in FIG. 15, in the calibration module 22, the switch SW2 on the comparator CPx side is turned OFF and the switch SW1 on the driver DRx side is turned ON, and the signal outputted by the driver DRx of the calibration module 22 is sent to the comparator CP1 of the pin electronics 11 through the performance board 30.

In this comparator CP1, as shown in FIG. 16, the position at which the signal rises (or falls) is detected, whereby the skew of the comparator CP1 is adjusted.

After the skew of the driver DR1 and the skew of the comparator CP1 are respectively adjusted in the manner as mentioned above, subsequently, the skew of the drivers DR2 to DRn and the skew of the comparators CP2 to CPn are adjusted for each pin.

In the meantime, when performing such calibration, the probe must be in contact with the performance board accurately.

In order to confirm the accurate contact, as shown in FIG. 17, conventionally, instead of a calibration module 22, a sampling oscilloscope 100 having a TDR function is connected to the terminal end of the probe 21, whereby a TDR waveform is observed on the screen (see JP-A-2002-228720 and JP-A-2001-183419, for example).

### DISCLOSURE OF THE INVENTION

### Problem to be Solved by the Invention

However, the method shown in FIG. 17 (the above-mentioned conventional technology) has a drawback that it takes a lot of cost since an oscilloscope is required to be provided separately. Furthermore, the need of disconnecting a calibration module and connecting an oscilloscope makes the operation complicated.

In addition, in a semiconductor testing apparatus which has been developed in recent years, high-speed performance is required in view of an increased number of pins which must be tested, i.e., ranging from several tens to several hundreds of pins. In the oscilloscope in the above-mentioned conventional technology, this analysis is performed after obtaining the entire waveform, which makes the testing speed slow. Therefore, the use of the oscilloscope is not suited to multiple pin measurement.

In the above-mentioned conventional technology, an inspection signal is sent from the driver of the pin electronics to the oscilloscope. If abnormality occurs on this signal path, the inspection signal cannot be inputted by the oscilloscope, which makes the conformity judgment of probe contact impossible. In addition, even though occurrence of abnormality on the signal path can be detected, the position of the signal path where the abnormality occurs cannot be detected.

The present invention has been made to solve the above-mentioned problems, and the object thereof is to provide a calibration apparatus, a contact judgment method and a semiconductor testing apparatus which enable probe contact judgment applicable to multiple pin measurement at a low cost with an easy operation and are capable of identifying the position on the signal path at which abnormality occurs.

### Means for Solving the Problem

In order to solve the problem, the calibration apparatus of the present invention comprises a calibration robot for bringing a probe into contact with a predetermined position on a performance board and a judging means for judging conformity of the contact, wherein the calibration robot is provided with a calibration module having a driver which outputs an inspection signal and a comparator which inputs a reflected wave, and the judging means judges conformity of contact and/or abnormality of a signal path based on the timing at which the reflected wave is inputted by the comparator through the probe after the driver inputs the inspection signal to the probe.

Due to such a configuration of the calibration apparatus, since conformity of the probe contact can be judged with the existing configuration without providing an oscilloscope, reduction in cost can be realized. Furthermore, conformity of contact can be judged only by turning each switch of the calibration module ON, without the need to connect or handle an oscilloscope, whereby operation can be simplified.

In addition, according to the present invention, only the position of the edge of a reflected wave is detected by the comparator, which is in contrast to a conventional oscilloscope technology in which an entire waveform is captured. Therefore, the present invention can shorten the time required for probe contact conformity judgment, and hence, is suited to multiple pin measurement.

Furthermore, since the comparator of the calibration module inputs a reflected wave, even if abnormality occurs on the signal path, it can detect the form of a wave which is reflected at the position where the abnormality occurs. In addition, since the input timing of a reflected wave varies depending on the position where abnormality occurs, the position at which abnormality occurs can be identified.

The calibration apparatus according to the present invention may have a configuration in which the calibration module is provided with a first switch for switching connection/non-connection between the driver and the probe and a second switch for switching connection/non-connection between the comparator and the probe and the judging means performs contact conformity judgment and/or signal path abnormality judgment based on the timing at which the comparator inputs a reflected wave when both the first switch and the second switch are turned such that connection is attained.

Due to such a configuration of the calibration apparatus, contact of the probe can be judged by turning the switch on the driver side and the switch on the comparator side respectively such that connection is attained (ON). As a result, conformity of probe contact can be performed by a simple operation.

The calibration apparatus according to the present invention may have a configuration in which the calibration module has a sampler obtained by combining a comparator and a sample hold.

Due to such a configuration of the calibration apparatus, the band of the calibrator is widened in an equivalent manner due to the use of the sampler. As a result, the output waveform timing in the driver and the reflected waveform timing in the comparator can be measured with a high degree of accuracy.

The calibration apparatus according to the present invention may have a configuration in which the judging means judges whether abnormality occurs on a path between the driver and the probe based on the timing at which the comparator inputs a reflected wave.

Furthermore, the calibration apparatus according to the present invention may have a configuration in which the judging means judges whether abnormality occurs on a path beyond the performance board based on the timing at which the comparator inputs a reflected wave.

Due to such a configuration of the calibration apparatus, occurrence of abnormality on a path between the driver and the probe, as well as occurrence of abnormality on a path beyond the performance board can be judged based on the timing at which the comparator inputs a reflective wave.

The contact judging method according to the present invention is a contact judging method which judges conformity of contact when a probe is brought into contact with a prescribed position on a performance board, wherein a driver of a calibration module provided in a calibration robot outputs an inspection signal to a probe, a comparator of the calibration module inputs a reflected wave which has been sent through the probe, and judging means performs contact conformity judgment and/or signal path abnormality judgment based on the timing at which the comparator inputs a reflective wave.

As mentioned above, the present invention can be utilized as a contact judging method.

The semiconductor testing apparatus of the present invention may have a configuration in which the semiconductor testing apparatus is provided with a calibration robot for bringing a probe into contact with a prescribed position on the performance board and a tester main body on which the performance board is installed, wherein the calibration robot comprises the calibration robot according to the present invention and judging means provided in the tester main body is the judging means according to the present invention.

Due to such a configuration of the semiconductor testing apparatus, probe contact conformity can be judged by using the calibration module provided in the calibration robot and the judging means provided in the tester main body. Since there is no need to provide an oscilloscope which has conventionally been used, cost reduction can be realized.

Furthermore, probe contact conformity can be judged simply by turning each switch in the existing calibration module without connecting an oscilloscope, whereby a simple operation can be realized.

### ADVANTAGEOUS EFFECTS OF THE INVENTION

As mentioned above, according to the present invention, since there is no need to use an oscilloscope which has conventionally been used for probe contact conformity judgment, cost reduction can be attained. Furthermore, troublesome operation can be avoided since connection of an oscilloscope becomes unnecessary.

Furthermore, due to the configuration in which a signal outputted by the driver is inputted to the comparator as a reflected wave by turning each switch of the calibration module ON, and probe contact conformity is judged according to this input timing, probe contact conformity can be judged accurately with a simple circuit configuration and by an easy operation.

In addition, unlike the conventional oscilloscope which captures the entire waveform, a technique is used to detect only the position of the edge of a reflected wave by the comparator, the time required for probe contact conformity, in particular the time required for the multiple pin measurement, can be shortened.

Furthermore, based on the input timing at which the comparator of the calibration module inputs a reflected wave, the position where abnormality occurs on the signal path can be identified.

### BRIEF DESCRIPTION OF THE DRAWINGS

FIG. 1 is a block diagram showing the configuration of the semiconductor testing apparatus according to the present invention;

FIG. 2 is a circuit diagram showing the path of an inspection signal when probe contact failure occurs;

FIG. 3 is a waveform illustration showing the waveform of an inspection signal outputted by the driver DRx;

FIG. 4 is a waveform illustration showing the waveform of a reflected wave inputted into the comparator CPx when no contact is made;

FIG. 5 is a circuit diagram showing the path of an inspection signal when the probe contact is normal;

FIG. 6 is a waveform illustration showing the waveform of a reflected wave inputted into the comparator CPx when normal contact is attained;

FIG. 7 is a waveform illustration showing the waveform of a reflected wave when abnormality occurs between the driver DRx and the probe;

FIG. 8 is a waveform illustration showing the waveform of a reflected wave when abnormality occurs between the performance board and the tester main body;

FIG. 9 is a circuit diagram showing the configuration in which a sampler is provided;

FIG. 10 is a waveform illustration showing the input waveform of the sampler and the waveform after sampling;

FIG. 11 is a circuit diagram showing the path of an inspection signal when a waveform is observed from the side of the pin electronics;

FIG. 12 is a circuit diagram showing the configuration of a conventional semiconductor testing apparatus;

FIG. 13 is a circuit diagram showing the signal path when the driver DR1 of the pin electronics is calibrated;

FIG. 14 is a waveform diagram showing the signal waveform when the drivers DR2 to DRn of the pin electronics is calibrated;

FIG. 15 is a circuit diagram showing the signal path when the comparator CP1 of the pin electronics is calibrated;

FIG. 16 is a waveform illustration showing the signal waveform when the comparators CP2 to CPn of the pin electronics are calibrated; and

FIG. 17 is a circuit diagram showing the configuration in which probe contact is judged by connecting an oscilloscope.

### BEST MODE FOR CARRYING OUT THE INVENTION

A preferred embodiment of the calibration apparatus, the contact judging method and the semiconductor testing apparatus according to the present invention will be explained with reference to the drawings.

### [Calibration Apparatus and Semiconductor Testing Apparatus]

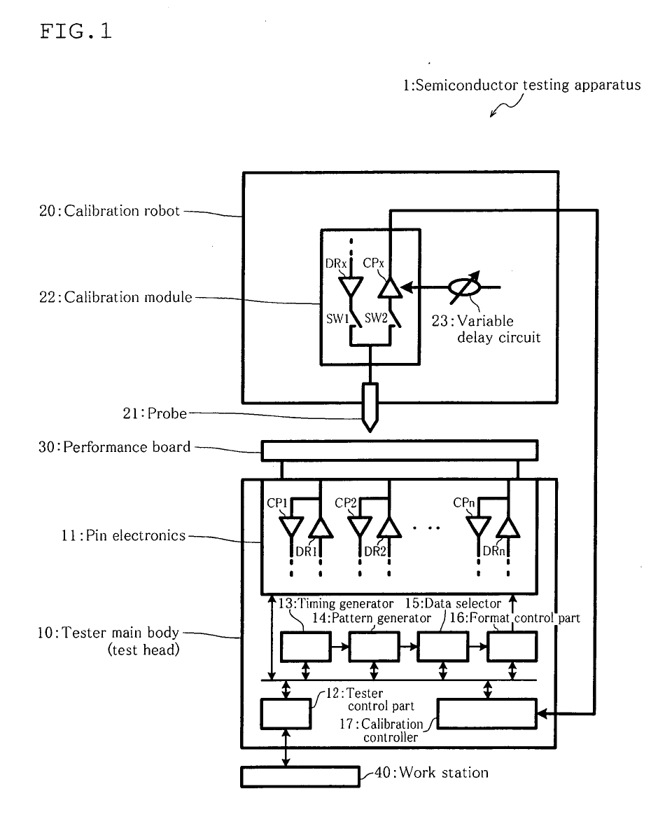

First, an embodiment of the calibration apparatus and the semiconductor testing apparatus of the present invention will be explained with reference to FIG. 1.

FIG. 1 is a schematic view showing the configuration of the semiconductor testing apparatus according to the present embodiment.

As shown in FIG. 1, the semiconductor testing apparatus 1 is provided with a tester main body (test head) 10, a calibration robot 20, a performance board 30 and a work station 40.

The tester main body 10 performs various tests for a device under test (not shown) by executing a prescribed test program which is transferred from a work station 40. The tester main body 10 performs timing calibration by executing a dedicated program transferred from the work station 40.

As shown in FIG. 1, the tester main body 10 has pin electronics 11, a tester control part 12, a timing generator 13, a pattern generator 14, a data selector 15, a format control part 16 and a calibration controller 17.

The pin electronics 11 serve to provide a physical interface between the semiconductor testing apparatus and a device under test. It generates a signal which is actually inputted and outputted between the semiconductor testing apparatus and an device under test based on a clock signal CLK or a strobe signal STB generated by waveform control by the format control part 16.

This pin electronics 11 have the driver groups DR1 to DRn and the comparator groups CP1 to CPn. The driver groups DR1 to DRn and the comparator groups CP1 to CPn and the performance board 30 are normally connected by a connector, a cable, a relay or the like. Since these components are not directly related to the present invention, they are not shown and the explanation thereof is omitted.

A tester control part 12 is connected with each constituting part such as a timing generator 13 through a bus 18, and, for each constituting part, performs control which is necessary for various testing operations or the calibration operation by executing a test program which has been transferred from the work station 40.

The timing generator 13 sets a basic cycle of the testing operation, and generates various timing edges included in the set basic cycle.

A pattern generator 14 generates pattern data to be inputted by each pin of a device under test.

A data selector 15 allows various pattern data outputted by the pattern generator to correspond to each pin of a device under test, which inputs this pattern data.

A format control part 16 performs waveform control for a device under test based on the pattern data which is generated by the pattern generator 14 and selected by the data selector 15 as well as on the timing edge generated by the timing generator 13.

A calibration controller (judging means) 17 receives an inspection signal from the comparator CPx of a calibration module 22 provided in a calibration robot 20, and performs various kinds of judgment based on the generation timing of this inspection signal.

The various kinds of judgment conducted by this calibration controller 17 include (1) probe contact conformity judgment, (2) path abnormality judgment between the driver DRx of the calibration module 22 and the probe 21, and (3) path abnormality judgment between the performance board 30 and the comparator CP1 to CPn of the tester main body 10. Details of these judgments will be mentioned later.

In FIG. 1, the calibration controller 17 is provided in the tester main body 10. However, provision of the calibration controller 17 is not limited to the tester main body 10. The calibration controller 17 may be provided in the work station 40 or the calibration robot 20.

The calibration robot 20 is provided with the probe 21, the calibration module 22 and a variable delay circuit 23.

By the movement of the calibration robot 20 in the X-Y-Z direction, the probe 21 is guided to a prescribed position on the performance board 30, where it is brought into contact with a prescribed pin.

The calibration module 22 has a driver DRx, a comparator CPx, a switch SW1 on the driver side and a switch SW2 on the comparator side.

The driver DRx outputs a test signal to the probe 21 by turning the switch SW1 on the driver side (first switch) such that connection is attained (ON).

The comparator CPx, by turning the switch SW2 on the comparator side (second switch) such that connection is attained (ON), inputs a reflected wave which has been sent through the probe 21, compares it with clock, and outputs a judging signal.

The variable delay circuit 23 delays clock, and then supplies the delayed clock to the comparator CPx. By changing the delay amount of this variable delay circuit 23, the comparator CPx can be operated at an arbitral timing. This enables the waveform of the driver DRx or timing to be observed.

In the meantime, the calibration robot 20 and the calibration controller 17 are referred to as the “calibration apparatus”.

The work station 40 controls a series of test operations such as a function test or an entire timing calibration operation, as well as provides an interface between the calibration apparatus and users.

In FIG. 1, the calibration controller 17 is provided in the tester main body 10. However, the calibration controller 17 may be provided in the work station 40, not in the tester main body 10.

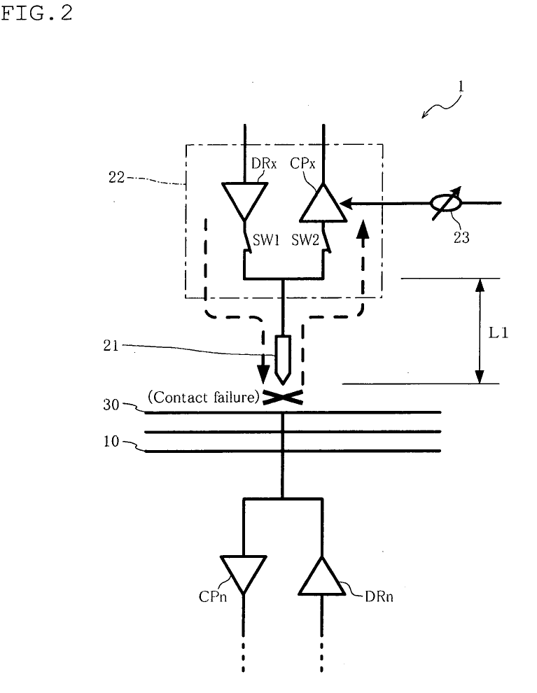

Then, the operation of the calibration in this embodiment will be explained with reference to FIGS. 2 to 6.

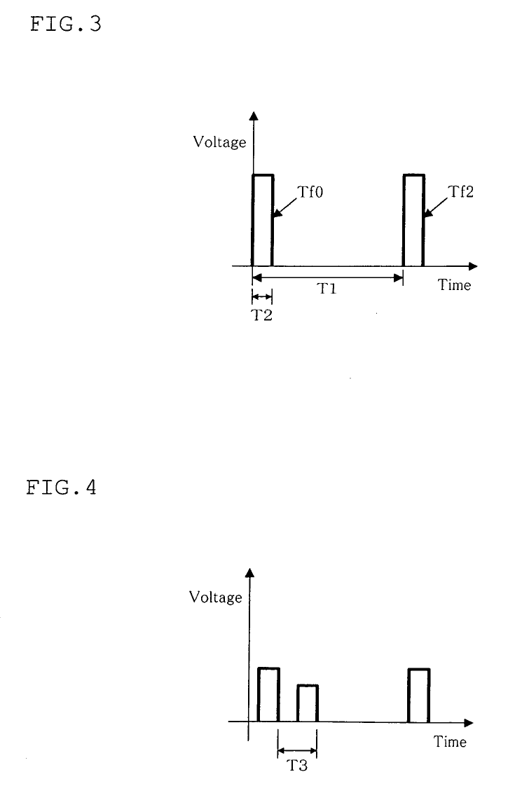

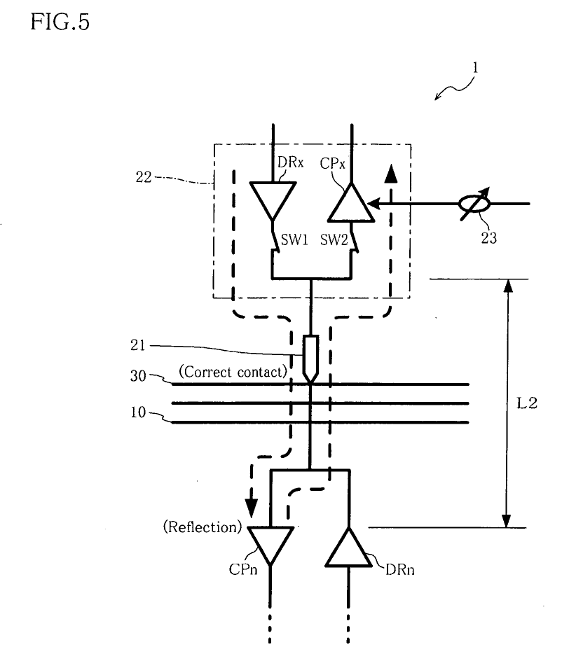

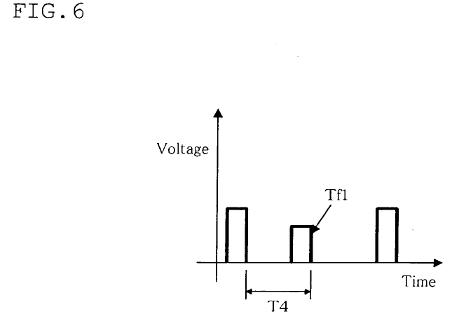

FIG. 2 is a circuit diagram showing the path of an inspection signal when the probe does not contact accurately. FIG. 3 is a waveform illustration showing the output waveform from the driver, FIG. 4 is a waveform illustration showing the waveform of a reflected wave in the case shown in FIG. 2, FIG. 5 is a circuit diagram showing the path of an inspection signal when the probe contacts accurately, and FIG. 6 is a waveform illustration showing the waveform of a reflected wave in the case shown in FIG. 5.

### [Preparation]

In the calibration module 22 of the calibration robot 20, as shown in FIG. 2, both the switch SW1 on the driver side and the switch SW2 on the comparator side are turned ON (connection is attained). This differs from, when performing calibration of the drivers DR1 to DRn or the comparators CP1 to CPn of the tester main body 10, turning one of the switch SW1 on the driver side and the switch SW2 on the comparator side ON with the remainder being OFF.

By turning both the switch SW1 on the driver side and the switch SW2 on the comparator side are turned ON, the output of the driver DRx can be returned to the input of the comparator CPx. Therefore, when a pulse is output by the driver DRx, a reflected wave is observed in the comparator CPx.

[Waveform of an Output from a Driver]

As shown in FIG. 3, an inspection signal is outputted by the driver DRx with a cycle T1.

In the meantime, the time T1-T2, taking the pulse width of an inspection signal as T2, is allowed to be longer than the time interval (T4) between the timing Tfl (see FIG. 6) which a reflected waveform is inputted which depends on L2 (the length from the calibration module 22 to the pin electronics 11, see FIG. 5) and the timing Tf0 at which a first inspection signal is outputted (falling timing). If the T1-T2 is shorter than T4, it becomes hard to distinguish an inspection signal from a reflected wave.

[Signal Path when the Probe does not Contact Accurately]

As shown in FIG. 2, an inspection signal in this case is, after being outputted by the driver DRx, reflected at the front end of the probe 21, and then returned to be inputted by the comparator CPx. If the time from the output by the driver DRx to the input of a reflected wave by the comparator CPx is taken as T3, as shown in FIG. 4, the T3 varies depending on the length L1 from the calibration module 22 to the front end of the probe 21, as shown in FIG. 2.

[Signal Path when the Probe Contacts Accurately]

As shown in FIG. 5, an inspection signal in this case is, after being outputted by the driver DRx, reaches the comparator CP of the pin electronics 11 through the probe 21 or the performance board 30, reflected, and then returned to be inputted into the comparator CPx of the calibration module 22.

If the time from the output by the driver DRx to the input of a reflected wave by the comparator CPx is taken as T4, as shown in FIG. 6, the T4 varies depending on the length L2 from the calibration module 22 to the pin electronics 11 (see FIG. 5).

In FIG. 4 or FIG. 6, the waveform is shown in a simplified form. Actually, the shape of the waveform will be a little more complicated since the waveforms are synthesized after repeating reflection a plurality of times.

### [Contact Conformity Judgment (Contact Judging Method)]

The judgment whether or not the probe 21 is in contact with the performance board 30 accurately is conducted as follows.

It can be judged that the probe 21 is in contact with the performance board 30 accurately if the following conditions (1) and (2) are satisfied. On the other hand, if one or both of the following conditions (1) and (2) are not satisfied, it can be judged that the probe 21 is not in contact with the performance board 30 accurately.

(1) The T4−T3 is a time lag calculated from the L2−L1
(2) The falling time Tf1 is the same as a falling time which is calculated from the falling time Tf0 of the output by the driver DRx and the band of the path

If the T4−T3 is not the time lag calculated from the L2−L1, it can be judged that the probe 21 suffers from contact failure. If the Tf1 differs from the value calculated from the Tf0 and the band of the signal path, it can be judged that the probe 21 suffers from contact failure.

### Examples of Other Judgments

In addition to the above-mentioned probe contact conformity judgment, abnormality of the calibration apparatus (semiconductor testing apparatus) can be judged according to the configuration in this embodiment.

### [Judgment on Abnormality of the Path Between the Driver of the Calibration Module and the Probe]

If the probe 21 does not contact the performance board 30 (when no contact is attained), if the input timing at which a reflected wave is inputted into the comparator CPx is outside the range of the expected value, it can be judged that abnormality occurs on the path between the driver DRx of the calibration module 22 and the probe 21.

The reason is as follows. If abnormality occurs on the path between the driver DRx and the probe 21, a reflected wave inputted into the comparator CPx through the path is affected by this abnormality, the reflective wave input timing falls outside the range of the expected value.

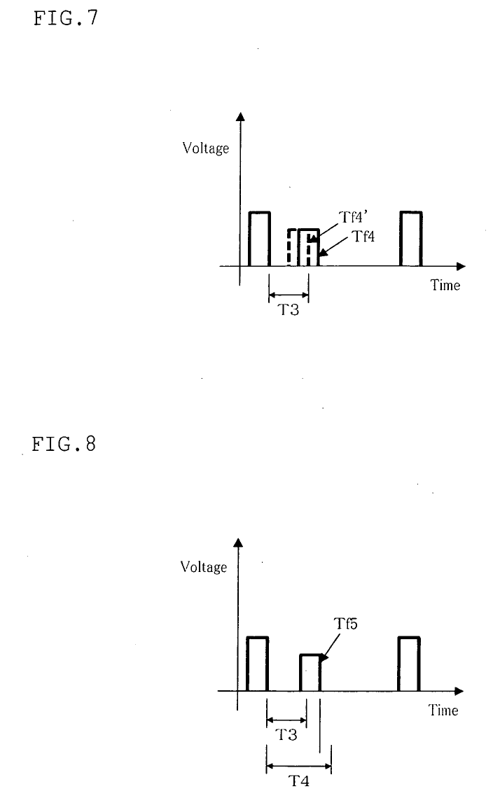

For example, as shown in FIG. 7, if the input timing Tf4′ at which the reflected wave is inputted into the comparator CPx (dashed line) is faster than the expected value Tf4 (solid line) (the reflected wave is returned faster), it can be judged that any abnormality occurs on the path between the driver DRx of the calibration module 22 and the probe 21.

### [Judgment on Abnormality of the Path Between the Performance Board and the Comparator of the Tester Main Body]

When an edge (Tf5 in FIG. 8) is detected between T3 and T4 although the probe 21 contacts the performance board 30 accurately, as shown in FIG. 8, it can be judged that an abnormality (disconnection or contact failure of the connector) occurs on the path beyond the performance board 30.

The reason therefor can be considered as follows. An edge is detected in T3 when an inspection signal is reflected at the front end of the probe 21 and an edge is detected in T4 when an inspection signal is reflected in comparators CP1 to CPn in the pin electronics 11 of the tester main body 10. Therefore, if an edge is detected between T3 and T4, it can be judged that an abnormality occurs between the performance board 30 with which the probe 21 is brought into contact and the comparators CP1 to CPn beyond this performance board 30.

These probe contact conformity judgment, the judgment on abnormality of the path between the driver of the calibration module and the probe and the judgment on abnormality of the path between the performance board and the comparator of the tester main body are each performed by the calibration controller 17 of the tester main body 10. The calibration controller 17 inputs a detection signal (a signal indicating that the comparator CPx inputs a reflected wave) from the comparator CPx of the calibration module 22, analyzes the timing of the edge (falling edge or rising edge) of this detection signal, and performs each judgment by the above-mentioned technique.

As mentioned hereinabove, according to the calibration apparatus, the contact judging method and the semiconductor testing apparatus in this embodiment, since an oscilloscope which has conventionally been used for probe contact uniformity is no longer required, equipment cost can be reduced. In addition, since connecting an oscilloscope is not necessary, troublesome works can be avoided.

Furthermore, due to a configuration in which the output signal from the driver is inputted into the comparator as a reflected wave by turning each switch of the calibration module ON and probe contact conformity is judged based on this input timing, the judgment can be performed easily and accurately with a simple operation.

In addition, unlike the conventional oscilloscopic technology in which the entire waveform is captured, due to a configuration in which only the position of an edge of a reflected wave is detected by the comparator, it is possible to provide a method for a probe contact conformity judgment, which is especially suited to the multiple pin measurement.

The preferred embodiment of the calibration apparatus, the contact judging method and the semiconductor testing apparatus of the present invention is explained hereinabove. However, the calibration apparatus, the contact judging method and the semiconductor testing apparatus of the present invention are not restricted to those mentioned in the above-mentioned embodiment. It is needless to say that various modifications are possible within the scope of the invention.

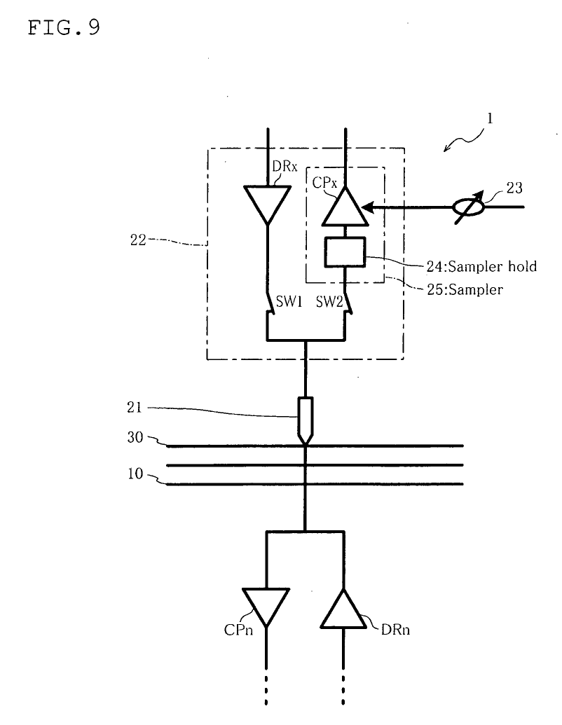

For example, in the above-mentioned embodiment, an explanation is made on the configuration in which the calibration module is provided with the driver and the comparator. However, as shown in FIG. 9, for example, instead of a comparator CPx, a sampler 25 obtained by combining the comparator CPx and the sample hold 24 may be provided.

Here, the sample hold 24 serves to widen an apparent band.

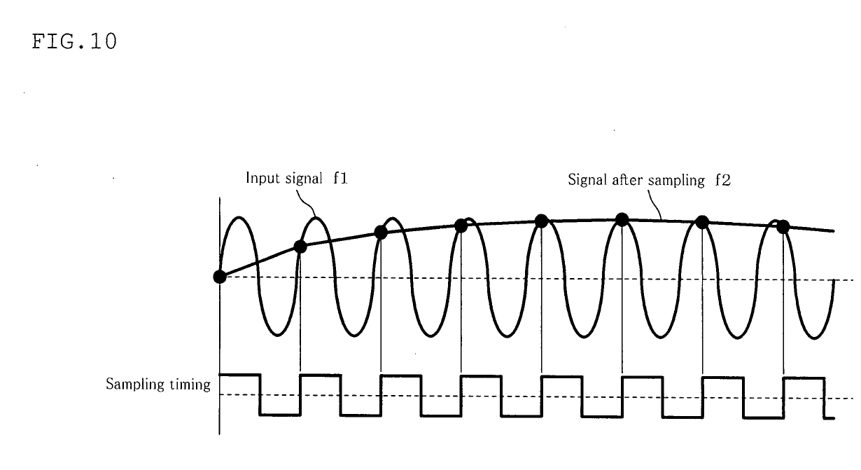

For example, as shown in FIG. 10, relative to the frequency of the input signal f1 of the sample hold 24, the frequency of the input signal f2 (signal after sampling) of the comparator CPx is decreased. The frequency is decreased in this way due to the presence of the sampler 25, it is possible to observe a signal with a frequency larger than the band of the comparator CPx. This appears to be the same as the principle of the undersampling of an AD converter.

In the case of the calibration module, an input signal is converted to a DC signal (undersampling) in order to allow the input signal frequency and the sampling frequency to be the same. That is, by using the sampler 25, the band of the comparator CPx is widened in an equivalent manner, and hence, measurement can be performed with a high degree of accuracy.

In FIGS. 3, 4, 6 or the like, the cycle T1 or the like is identified by using the timing at which the falling of an inspection signal occurs. However, the present invention is not limited to the falling, and the cycle T1 or the like can be identified also by using the timing at which the rising of an inspection signal occurs.

In addition, according to the present invention, not only the reflected waveform of a signal can be observed from the side of the calibration apparatus, but also the reflected waveform can be observed from the pin electronics, thus enabling contact test to be performed.

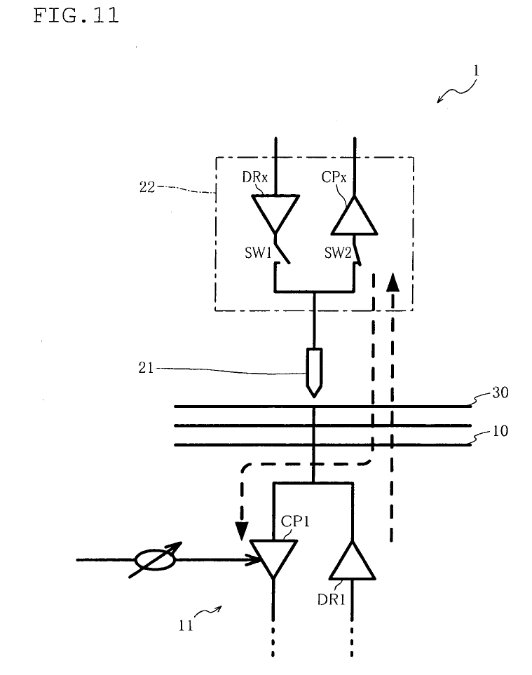

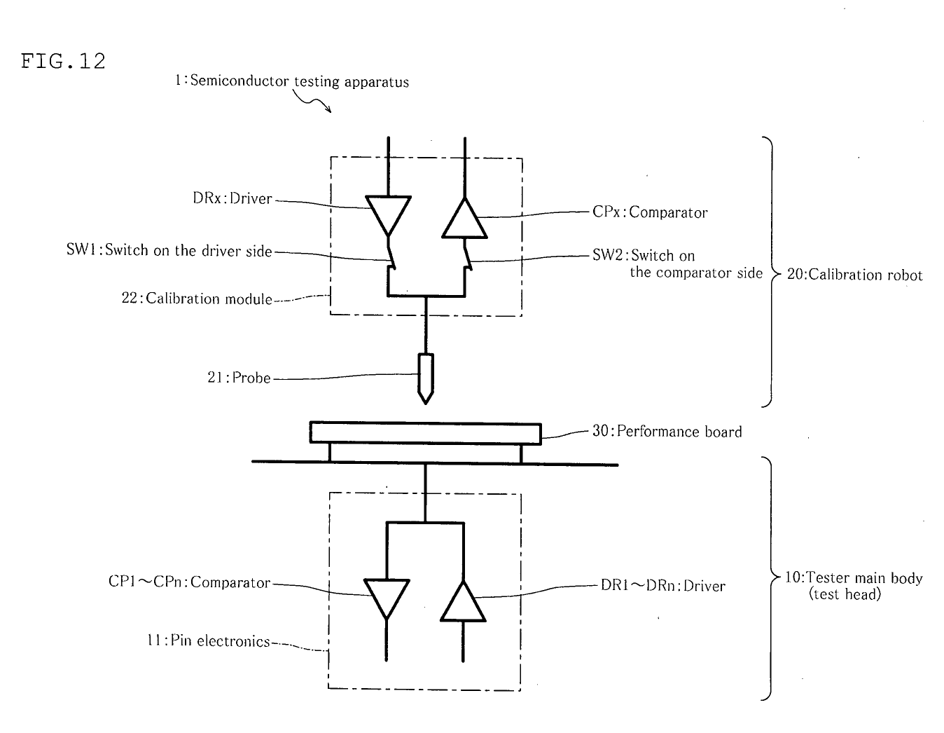

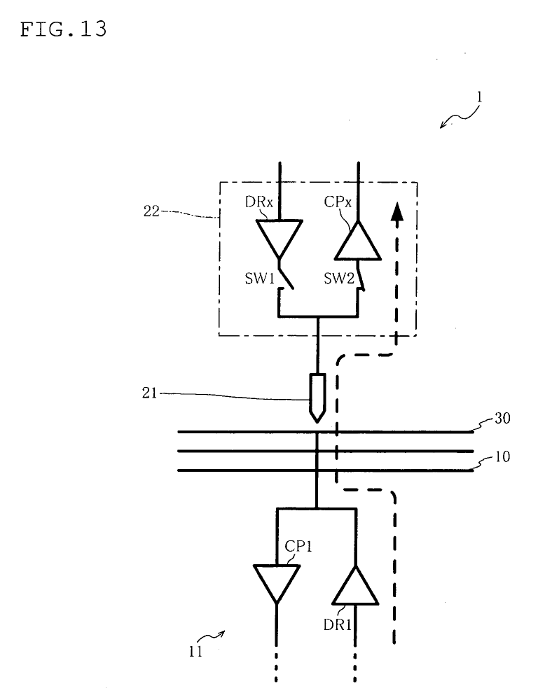

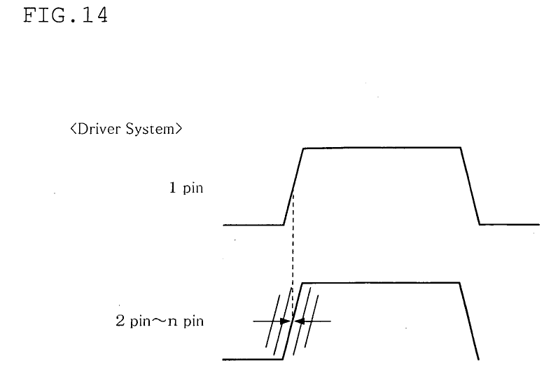

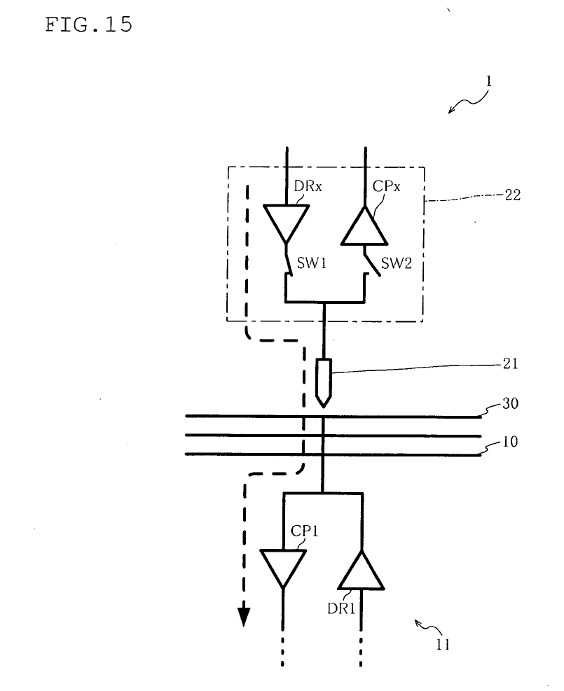

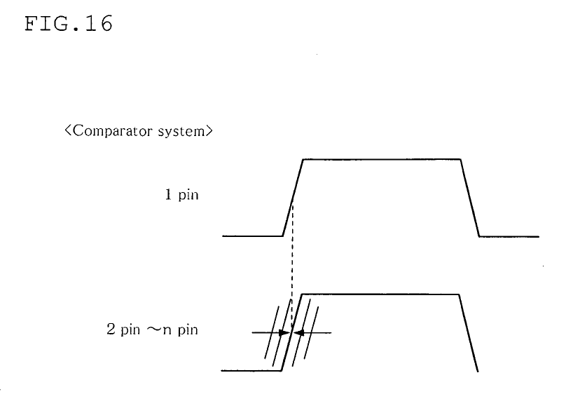

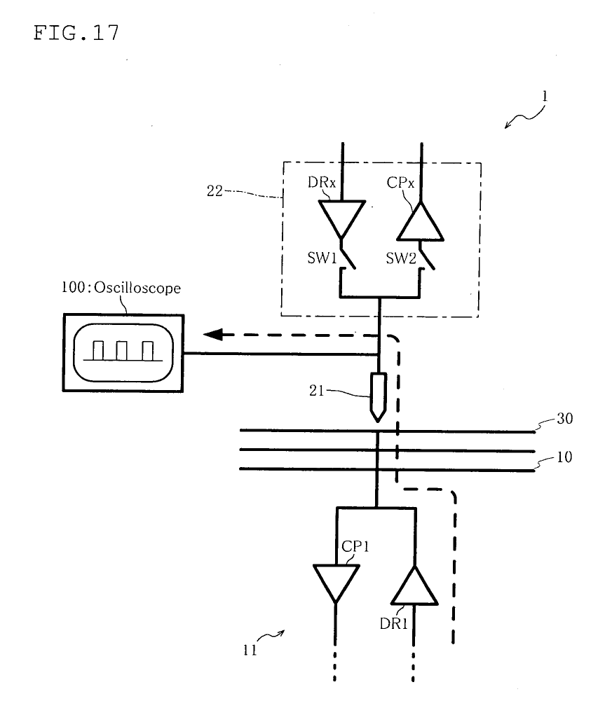

That is, as shown in FIG. 11, an inspection signal is sent from the pin electronics to the calibration apparatus, and the reflected wave is inputted and observed by the pin electronics. As a result, as in the case of the embodiments mentioned above, probe contact conformity, path abnormality or the like can be detected and judged.

### INDUSTRIAL APPLICABILITY

The present invention relates to probe contact. Therefore, the present invention can be applied to a device or an apparatus which performs probe contact.

1. A calibration apparatus comprising a calibration robot for bringing a probe into contact with a predetermined position on a performance board and a judging means for judging conformity of the contact, wherein
the calibration robot is provided with a calibration module having a driver which outputs an inspection signal and a comparator which inputs a reflected wave, and
the judging means judges conformity of contact and/or abnormality of a signal path based on the timing at which the reflected wave is inputted by the comparator through the probe after the driver inputs the inspection signal to the probe.

2. The calibration apparatus according to claim 1, wherein
the calibration module is provided with a first switch for switching connection/non-connection between the driver and the probe and a second switch for switching connection/non-connection between the comparator and the probe, and
the judging means performs contact conformity judgment and/or signal path abnormality judgment based on the timing at which the comparator inputs a reflected wave when both the first switch and the second switch are turned such that connection is attained.

3. The calibration apparatus according to claim 1, wherein
the calibration module has a sampler obtained by combining a comparator and a sample hold.

4. The calibration apparatus according to claim 1, wherein
the judging means judges whether abnormality occurs on a path between the driver and the probe based on the timing at which the comparator inputs a reflected wave.

5. The calibration apparatus according to claim 1, wherein
the judging means judges whether abnormality occurs on a path beyond the performance board.

6. A contact judging method which judges conformity of the contact when a probe is brought into contact with a prescribed position on a performance board, comprising the following steps of:
a driver of the calibration module provided in a calibration robot outputs an inspection signal to a probe,
a comparator of the calibration module inputs a reflected wave which has been sent through the probe, and
judging means performs contact conformity judgment and/or signal path abnormality judgment based on the timing at which the comparator inputs a reflective wave.

7. A semiconductor testing apparatus which is provided with a calibration robot for bringing a probe into contact with a prescribed position on the performance board and a tester main body on which the performance board is installed, wherein
the calibration robot comprises the calibration robot which is provided with a calibration module having a driver which outputs an inspection signal and a comparator which inputs a reflected wave, and
judging means is provided in the tester main body for judging conformity of contact and/or abnormality of a signal path based on the timing at which the reflected wave is inputted by the comparator through the probe after the driver inputs the inspection signal to the probe.
